(19) United States
(12) Patent Application Publication
(10) Pub. No.: US 2025/0321852 A1
(43) Pub. Date: Oct. 16, 2025

(54) DYNAMIC MODEL SELECTION AND ROUTING USING PROMPT PROCESSING UNITS

(71) Applicant: Cisco Technology, Inc., San Jose, CA (US)

(72) Inventors: Benjamin William Ryder, Lausanne (CH); Marcelo Yannuzzi, Nuvilly (CH); Arash Salarian, Chardonne (CH); Jean Andrei Diaconu, Gaillard (FR); Hervé Muyal, Gland (CH)

(73) Assignee: Cisco Technology, Inc., San Jose, CA (US)

(21) Appl. No.: 18/931,642

(22) Filed: Oct. 30, 2024

Related U.S. Application Data
(60) Provisional application No. 63/633,450, filed on Apr. 12, 2024.

(51) Int. Cl. G06F 11/34; G06F 40/284

(52) U.S. Cl. CPC G06F 11/3447; G06F 11/3428; G06F 40/284

(57) ABSTRACT

In one implementation, a device may identify a task requested by a prompt for input to a language model. The device may compute, based on the task, two or more estimated performance metrics for each of a plurality of candidate language models associated with that model performing the task. The device may select a particular language model from among the plurality of candidate language models to optimize the two or more estimated performance metrics. The device may cause the prompt to be sent to the particular language model for performance of the task.

### RELATED APPLICATION

This application claims priority to U.S. Prov. Appl. Ser. No. 63/633,450, filed Apr. 12, 2024, for DYNAMIC MODEL SELECTION AND ROUTING USING PROMPT PROCESSING UNITS, by Ryder, et al., the contents of which are incorporated herein by reference.

### TECHNICAL FIELD

The present disclosure relates generally to computer networks, and, more particularly, to dynamic model selection and routing using prompt processing units (PPUs).

### BACKGROUND

Recent breakthroughs in large language models (LLMs), such as ChatGPT and GPT-4, represent new opportunities across a wide spectrum of industries. More specifically, the ability of these models to follow instructions now allows for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

However, choosing the right LLM and/or the right parameters of an LLM to use can be quite challenging given the diversity of performance, latency, etc. amongst available models and/or the diversity of prompts to these models. Unfortunately, there are no existing mechanisms that can facilitate a data-driven approach to model selection. Conventional model selection is therefore typically a matter of using a default model that is applied across all prompts or selecting a model based on user guesswork, often resulting in suboptimal model utilization. Suboptimal model selection can negatively impact system performance, operational/computational costs, and/or delays.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example of an environment for dynamic model selection and routing using PPUs;

FIG. 4 illustrates an example architecture, including a PPU, to facilitate dynamic model selection and routing;

FIGS. 5A-5C illustrate system components for selecting an optimal LLM for execution of a given prompt;

FIG. 6 illustrates an example of an architecture of inputs and/or outputs for model selection and routing component operations for dynamically selecting an LLM for execution of a given prompt; and

FIG. 7 illustrates an example of a simplified procedure for PPU-based dynamic model selection and routing, in accordance with one or more implementations described herein.

### DESCRIPTION OF EXAMPLE IMPLEMENTATIONS

### Overview

According to one or more implementations of the disclosure, a device may identify a task requested by a prompt for input to a language model. The device may compute, based on the task, two or more estimated performance metrics for each of a plurality of candidate language models associated with that model performing the task. The device may select a particular language model from among the plurality of candidate language models to optimize the two or more estimated performance metrics. The device may cause the prompt to be sent to the particular language model for performance of the task.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

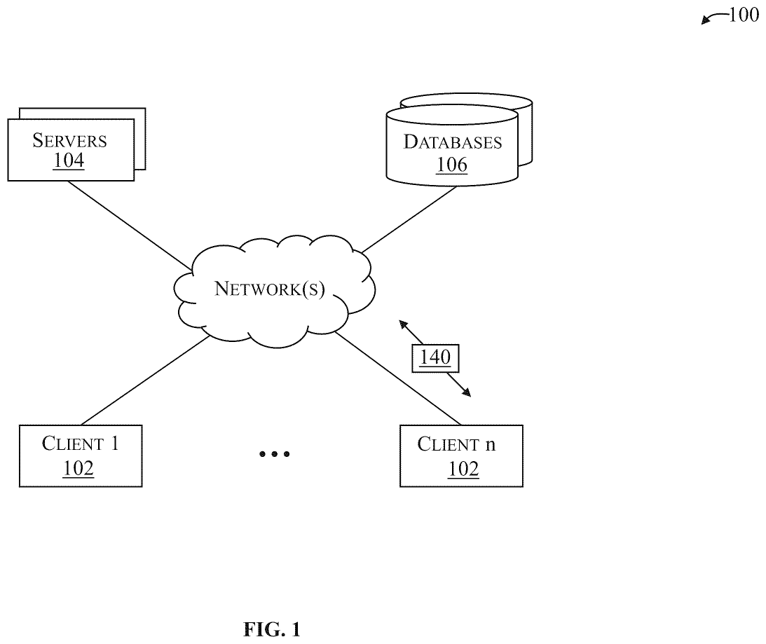

FIG. 1 is a schematic block diagram of an example simplified computing system (e.g., computing system 100) illustratively comprising any number of client devices (e.g., client devices 102 with, e.g., a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, servers 104 and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

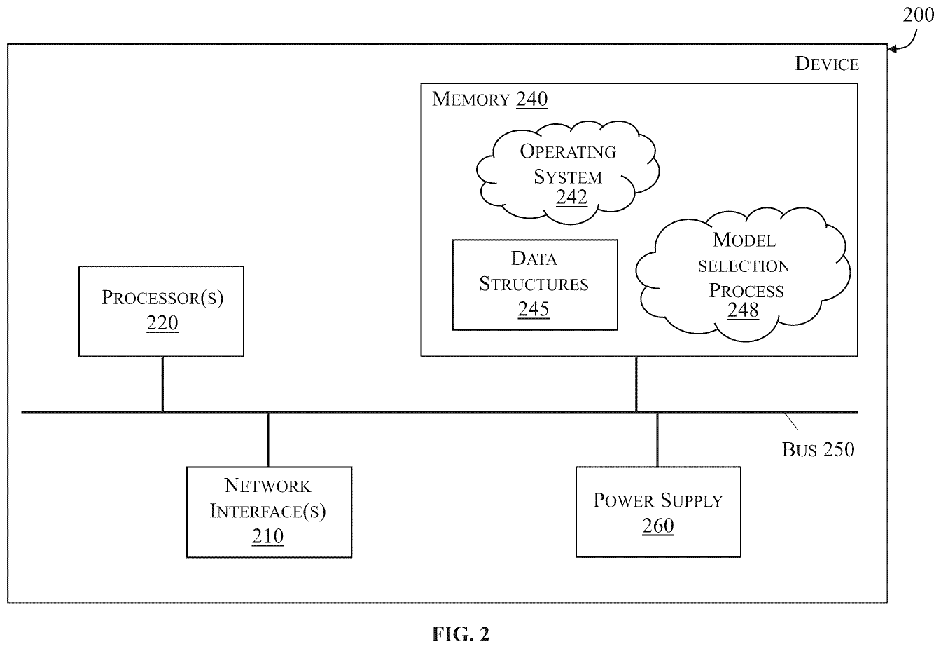

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components and/or services may comprise a model selection process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, model selection process 248 may include computer-executable instructions that, when executed by processor(s) 220, cause device 200 to perform the techniques described herein. To do so, in some implementations, model selection process 248 may utilize non-machine learning based techniques (e.g., a look up based on the output of a PPU) and/or machine learning based techniques to perform dynamic model selection and/or routing utilizing PPUs. In general, machine learning is concerned with the design and the development of techniques that take as input empirical data (such as network statistics and performance indicators) and recognize complex patterns in these data.

In various implementations, model selection process 248 may employ and/or perform model selection amongst one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that model selection process 248 can employ and/or perform model selection amongst may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, model selection process 248 may also include and/or perform model selection amongst one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, model selection process 248 may use and or select a generative model to perform tasks for the enterprise. Example generative approaches can include, but are not limited to, generative adversarial networks (GANs), large language models (LLMs), other transformer models, and the like.

As noted above, although many enterprises aim to leverage LLMs, choosing the right LLM and/or the parameters of an LLM to use can be quite challenging. Indeed, different LLMs offer different levels of performance, latency, etc. Moreover, the “best” LLM to use can vary on a prompt-by-prompt basis both from the perspective of which metrics are most important for a given prompt, as well as what those metrics would be for a given LLM.

Unfortunately, users presently lack mechanisms to facilitate a data-driven approach to model and/or parameter selection. Conventional model and/or parameter selection is therefore typically a matter of using a default model that is applied across all prompts or selecting a model based on user guesswork, often resulting in suboptimal model utilization. Suboptimal model and/or model parameter selection can negatively impact system performance, operational/computational costs, and/or delays.

### Dynamic Model Selection and Routing Using Prompt Processing Units

The techniques described herein introduce a mechanism for dynamic model selection and routing using PPUs. For example, these techniques leverage PPUs to assess an incoming prompt and its corresponding metadata, to characterize the prompt, and/or to inform an LLM selection process for execution of the prompt. These techniques may enable enterprises to dynamically identify the most suitable LLM to process an individual prompt at inference time, considering the output of a PPU, normalized metrics (e.g., performance (P), cost (C), delay (D), etc.) associated to each of the LLMs available to the enterprise, and/or external sources of information (e.g., leaderboards, etc.). In addition, these techniques may enable enterprises to dynamically identify the best parameters of an LLM for processing a particular prompt.

Illustratively, the techniques described herein may be performed by hardware, software, and/or firmware, such as in accordance with model selection process 248, which may include computer executable instructions executed by the processor(s) 220 (or independent processor of the network interfaces 210) to perform functions relating to the techniques described herein. Further, they may be combined with post-processing methods to provide aggregated and/or historical visibility of prompt features and insights across an enterprise.

Specifically, according to various implementations, a device may identify a task requested by a prompt for input to a language model. The device may compute, based on the task, two or more estimated performance metrics for each of a plurality of candidate language models associated with that model performing the task. The device may select a particular language model from among the plurality of candidate language models to optimize the two or more estimated performance metrics. The device may cause the prompt to be sent to the particular language model for performance of the task.

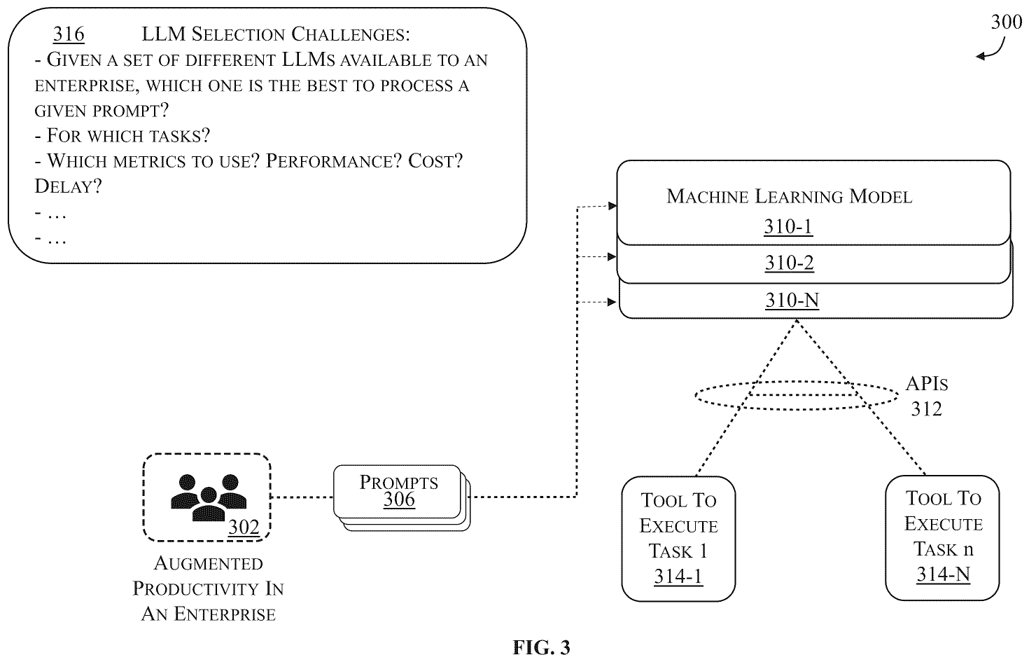

Operationally, FIG. 3 illustrates an example of an environment 300 for dynamic model selection and routing using prompt processing units. In environment 300, some or all of the system may be enterprise controlled. For example, prompts 306 may be submitted (e.g., via a user chat interface or an API) within an enterprise-controlled portion of the system. The ability of users 302 to submit these prompts 306 may facilitate augmented productivity. For instance, sales, marketing, customer support, data analytics, engineering, product management, etc. may all utilize the prompts 306 to enhance their productivity.

Typically, the system may pass prompts 306 to one or more of the machine learning models 310 (e.g., 310-1 . . . 310-N) for processing and/or execution. For instance, machine learning models 310 may be generative AI models, such as an LLM or other language and/or vision model. In some instances, machine learning models 310 can be hosted by third party providers and/or self-hosted. In addition, machine learning model 310 may be fine-tuned and/or open source or public models. Machine learning model 310 may be served as part of larger systems that may also include pre-integrated application programming interfaces (APIs) and/or tools to orchestrate, execute, and chain various tasks before responding to a query carried in a prompt.

Although many enterprises aim to leverage generative AI, selecting the right LLM and/or the right parameters for an LLM for a given prompt is not a trivial challenge. This may involve identification of what tasks are requested by prompts 306 for performance by machine learning models 310. Additionally, this may involve identification of the effectiveness of each of the machine learning models 310 in completing the requested tasks as well as what data is sent, used, and returned by these third-party systems. Consequently, while the prompts 306, users 302, any corresponding API calls that they may make, and/or sometimes a machine learning model 310 may be within the enterprise-controlled portion, an enterprise may wish to address LLM selection challenges 316 on a prompt-by-prompt basis to enable more sophisticated controls (e.g., dynamically optimizing model selection and routing) over which LLMs and/or which LLM parameters are utilized to process prompts 306.

In various implementations, LLM selection challenges 316 may be addressed by the disclosed techniques using prompt processing units (PPUs). In addition, tools 314 (e.g., 314-1 . . . 314-N) for executing various tasks may be communicatively coupled (e.g., via APIs 312) to the machine learning models 310 and/or may be operable to participate in the execution of tasks specified in prompts 306.

Machine learning models 310 and/or tools 314 may be equipped to “interpret” open-ended prompts and act upon them by generating artifacts or executing various tasks based on such “understanding.” However, this skill is currently not accessible to an enterprise attempting to gain visibility and institute controls within the enterprise-controlled portion. This lack of understanding and natural-language native techniques hinders the observation and comprehension of what are the tasks requested in a prompt and/or which of the machine learning models 310 is a best option to execute that prompt before the prompt is processed by external entities.

However, these features may be enabled, and facilitated, within environment 300 using prompt processing units (PPUs). Hence, environment 300 may be modified by incorporating an observability system that leverages the PPUs. For example, the PPUs may parse a query and/or detect a set of key features from prompts 306 in a systematic manner. The observability system may then leverage these characterizations to facilitate optimized dynamic model selection and routing on a prompt-by-prompt basis both from the perspective of which metrics are most important for a given prompt, as well as what those metrics would be for a given LLM.

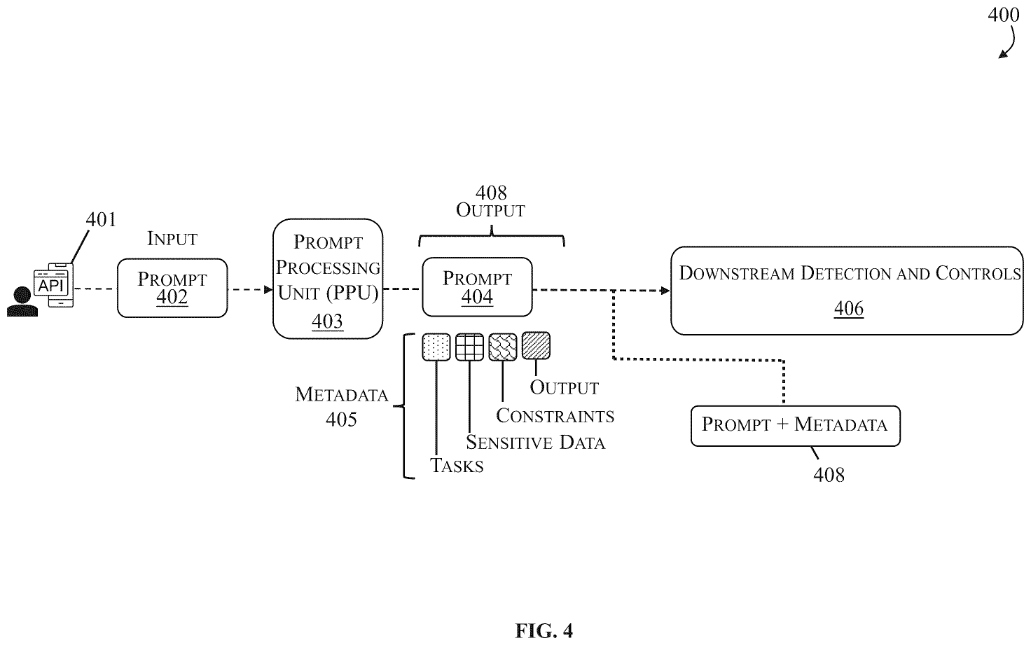

FIG. 4 illustrates an example architecture 400 including a prompt processing unit (PPU 403) configured to facilitate dynamic model selection and routing. Architecture 400 may be a portion of a data control system that leverages the outputs of the PPU 403 to institute sophisticated threat detection, downstream data controls, prompt optimization, data monitoring, resource utilization monitoring, prompt-level LLM model selection and routing, etc. Typically, architecture 400 may be implemented at the enterprise-controlled portion of the system, although other implementations provide for some or all of its components to be executed externally, as well.

In general, PPU 403 may be a highly efficient processing element that may receive a prompt 402 as an input (e.g., from a user chat interface or an API 401). PPU 403 may parse the prompt 402 and/or may detect a set of key features from prompt 402, to extract metadata 405 from it. For instance, PPU 403 may detect key features within prompt 402 for inclusion in metadata 405 such as the tasks requested, the sensitive data entailed to complete the tasks, any constraints applicable to complete the tasks, and/or the desired output upon completion of such tasks.

PPU 403 may also act as a transparent element, delivering the unmodified prompt 404 augmented with metadata 405 carrying the key features, such as those described above, as output 408. More specifically, a PPU 403 may systematically distill and characterize prompts, thereby enabling new and sophisticated controls downstream 406 (e.g., dynamically optimized model selection and routing on a prompt-by-prompt basis), as described further below.

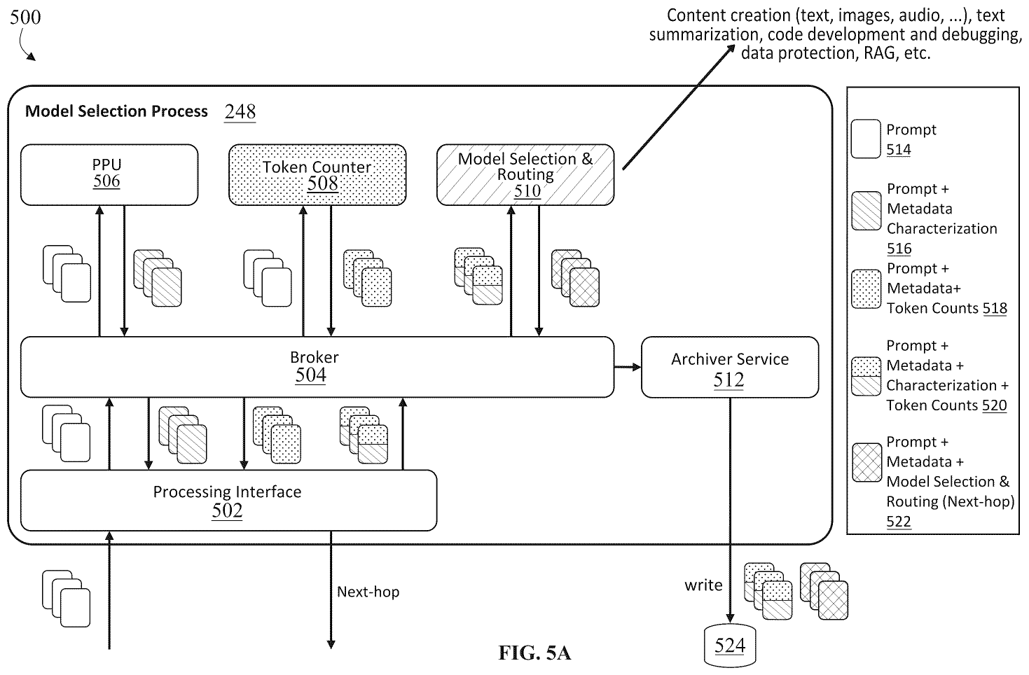

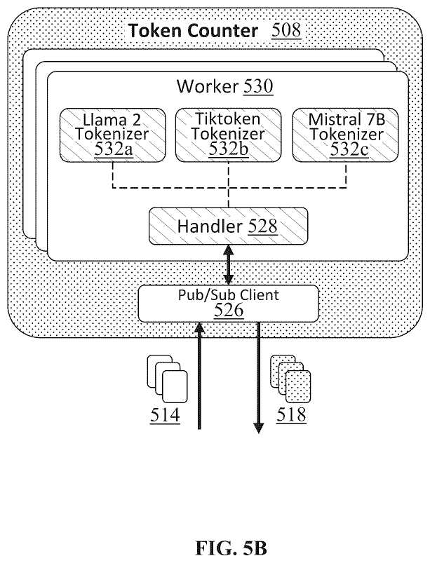

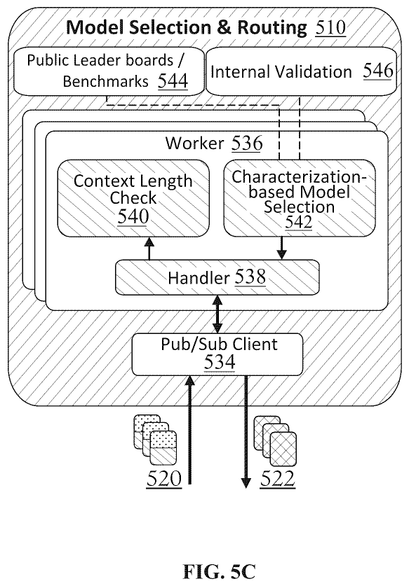

FIGS. 5A-5C illustrate an example for selecting an optimal LLM for execution of a given prompt. The system shown according to architecture 500 may enable companies to dynamically identify the most suitable LLM to process an individual prompt at inference time, considering: the output of a prompt processing unit (PPU); normalized metrics (e.g., performance (P), cost (C), delay (D), etc.) associated to each of the LLMs available to the company, and/or external sources of information (e.g., leaderboards).

FIG. 5A illustrates an example architecture 500 for model selection process 248, in various implementations. As shown, model selection process 248 may include any or all of the following components: a processing interface 502, a data broker 504, a PPU 506, a token counter 508, a model and selection component 510, and/or an archiver service 512. In various implementations, the functionalities of these components may be combined or omitted, as desired. In addition, some implementations provide for these components to be executed in a distributed manner, in which case the set of executing devices may itself be viewed as a device for purposes of the teachings herein.

As shown, model selection process 248 may receive a prompt 514 input by a user via a user interface (e.g., by using a chatbot, other application, etc.), generated automatically by an application, or from any other source. Typically, model selection process 248 may be executed on-prem, or on a private cloud or datacenter managed by an enterprise, allowing it to assess prompt 514 prior to it being passed to a model for processing. However, other instances provide for model selection process 248 to be executed by any intermediary between the endpoint user and the remote model (e.g., on a SaaS instance managed and created for an enterprise).

In general, processing interface 502 may be responsible for taking as input prompt 514 and providing the resulting output to the next-hop (e.g., to the selected model). Broker 504 may be responsible for acting as a data broker between PPU 506, token counter 508, model selection and routing component 510, and archiver service 512 during processing of prompt 514.

Here, processing interface 502 may pass prompt 514 to data broker 504, which sends it on to PPU 506. As described previously, PPU 506 may analyze prompt 514 to extract metadata from it indicative of the tasks, sensitive data, constraints, and/or output associated with prompt 514. In turn, PPU 506 may return output 516 to data broker 504 that includes the extracted metadata characterization of prompt 514.

Similarly, as described in further detail in FIG. 5B, data broker 504 may also pass prompt 514 to token counter 508, which may be responsible for determining the token counts associated with prompt 514. Indeed, different LLMs and other machine learning models often have restrictions in terms of the number of tokens that are allowed to be passed to them, which could affect the model selection by model selection and routing component 510. Accordingly, the output 518 back to data broker 504 may augment 514 with the token counts.

Based on the combined information 520 of prompt 514, its metadata characterization from PPU 506, and its token counts from token counter 508, model selection and routing component 510 may determine which model (e.g., LLM) is the most appropriate to process prompt 514. As detailed below in FIG. 5C, may return an output 522 back to broker 504 that augments the processing data with the selection. This allows processing interface 502 to send prompt 514 to the next hop towards the selected model.

In some instances, model selection process 248 may also leverage archiver service 512 to write combined information 520 and/or output 522 to a data store 524. Doing so allows an administrator to review the history of which prompt was sent to which model, as well as the information that model selection process 248 used to make the selection.

FIG. 5B illustrates token counter 508 in greater detail, in various implementations. As shown, token counter 508 may include a pub/sub client 526 responsible for interacting with data broker 504. Thus, when a new prompt 514 is published to data broker 504, pub/sub client 526 may pass it to a worker process 530. Within worker process 530 may be a handler 528 that passes prompt 514 to any number of tokenizers, such as tokenizer 532a (e.g., a Llama 2 tokenizer), tokenizer 532b (e.g., a Tiktoken tokenizer), tokenizer 532c (e.g., a Mistral 7B tokenizer), etc. This allows handler 528 to determine the counts of tokens in prompt 514 as aggregate counts and/or separate counts for the different tokenizers 532, as different LLMs may use different tokenizers.

FIG. 5C illustrates routing component 510 in greater detail, in various implementations. Similar to token counter 508, routing component 510 may include a pub/sub client 534 configured to interface with data broker 504. Thus, when PPU 506 and token counter 508 have finished their assessments of a new prompt 514, sub client 534 may take as input the resulting output 520, which may include the prompt, its metadata and categorization, as well as its token counts. In turn, sub client 534 may pass this information to a worker process 536, which may include two sub-modules: module 540 responsible for performing a context length check and a module 542 responsible for making a characterization-based model selection.

Here, module 542 may take into account factors such as benchmarks 544 for the various possible models, such as those available from public leaderboards, and/or internal validation information 546 for the different models. Indeed, certain LLMs may be more capable of performing certain types of tasks over others, may operate faster, etc. In addition, module 542 may take into account the token counts, etc., as different LLMs may have different maximum token lengths, costs associated with the number of tokens used, and the like.

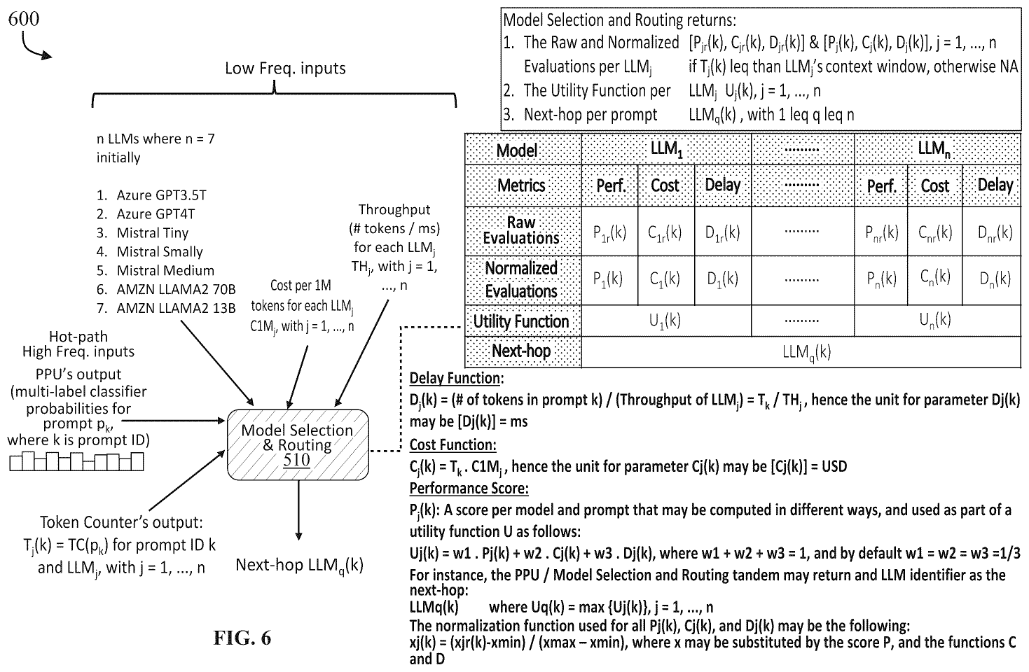

FIG. 6 illustrates an example of an architecture 600 of inputs and/or outputs for model selection and routing component 510 for selecting an optimal LLM for execution of a given prompt. In architecture 600, model selection and routing component 510 may assess the benefits and pitfalls of using each of a set of LLMs, to select which one to send the prompt. This may facilitate the dynamic selection of the best LLM to process a given prompt, taking into account various factors.

In addition, model selection and routing component 510 may also be utilized to identify optimal parameters of an LLM for a particular prompt. For example, if a prompt requires more creativity (e.g., as detected by the PPU) then the temperature parameter of the “right LLM” could also be set as part of the routing.

In various embodiments, a delay function D, a cost function C, and a Performance score P may be computed as follows:

$${D}_{j} ( k ) = ( \# of tokens in prompt k ) / ( Throughput of {LLM}_{j} ) = {T}_{k} / {TH}_{j} , hence the unit for parameter {D}_{j} ( k ) may be [ {D}_{j} ( k ) ] = ms$$

$${C}_{j} ( k ) = {T}_{k} \cdot C 1 {M}_{j} , hence the unit for parameter {C}_{j} ( k ) may be [ {C}_{j} ( k ) ] = USD$$

Pⱼ(k): A score per model and prompt that may be computed in different ways, and used as part of a utility function U as follows:

$${U}_{j} ( k ) = {w}_{1} \cdot {P}_{j} ( k ) + {w}_{2} \cdot {C}_{j} ( k ) + {w}_{3} \cdot {D}_{j} ( k ) , where {w}_{1} + {w}_{2} + {w}_{3} = 1 , and by default {w}_{1} = {w}_{2} = {w}_{3} = 1 / 3$$

For instance, the PPU/Model Selection and Routing tandem may return and LLM identifier as the next-hop:

$${LLM}_{q} ( k ) where {U}_{q} ( k ) = max \{ {U}_{j} ( k ) \} , j = 1 , … , n$$

The normalization function used for all Pⱼ(k), Cⱼ(k), and Dⱼ(k) may be the following:
xⱼ(k)=(xⱼᵣ(k)−xₘᵢₙ)/(xₘₐₓ−xₘᵢₙ), where x may be substituted by the score P, and the functions C and D

In an example implementation, the output of model selection and routing 510 may include:
1. The raw and normalized evaluations per LLMⱼ:
   [Pⱼᵣ(k), Cⱼᵣ(k), Dⱼᵣ(k)] & [Pⱼ(k), Cⱼ(k), Dⱼ(k)], j=1, . . . , n if Tⱼ(k) leq than LLMⱼ's context window, otherwise NA
2. The utility function per model j:

$${LLM}_{j} {U}_{j} ( k ) , j = 1 , … , n$$

3. Next-hop per prompt:
   LLMq(k), with 1 leq q leq n.

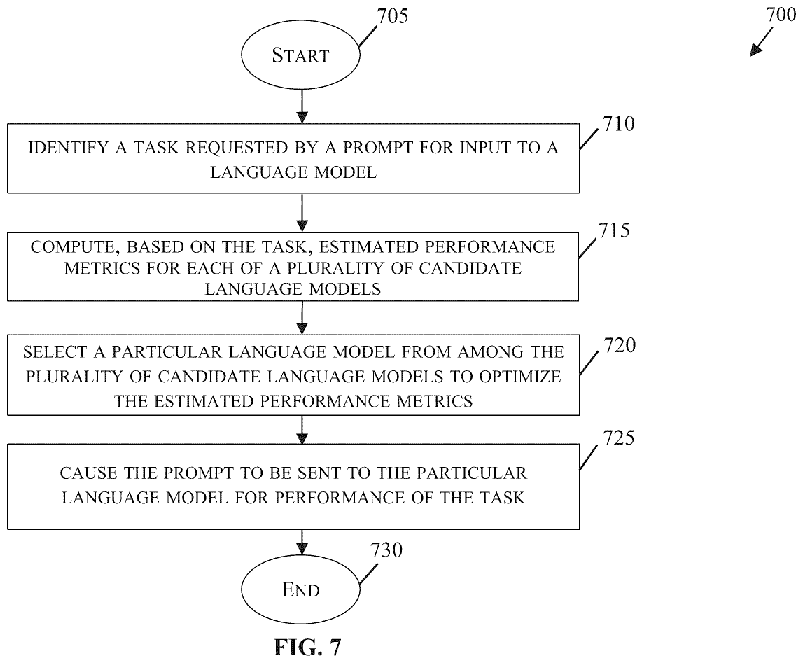

FIG. 7 illustrates an example simplified procedure for PPU-based dynamic model selection and routing, in accordance with one or more implementations described herein. For example, a non-generic, specifically configured device (e.g., device 200), may perform procedure 700 (e.g., a method) by executing stored instructions (e.g., model selection process 248).

The procedure 700 may start at step 705, and continues to step 710, where, as described in greater detail above, the device (e.g., a controller, processor, etc.) may identify a task requested by a prompt for input to a language model. For example, the prompt may be parsed to generate a prompt characterization (e.g., by a PPU). The prompt characterization may include an indication of the task requested by the prompt. In some instances, a task characterization of the task requested by the prompt for input to the language model may be determined.

At step 715, as detailed above, a device may compute, based on the task and/or the task characterization, two or more estimated performance metrics for each of a plurality of candidate language models associated with that model performing the task. The two or more estimated performance metrics may include a characterization of one or more of an accuracy, a cost, or a delay associated with a corresponding language model of the plurality of candidate language models associated with that model performing the task. Therefore, computing the two or more estimated performance metrics may include estimating the performance metrics of each of the plurality of candidate language models based on the accuracy, cost, and/or a delay associated with that language model performing that type of task.

In some instances, the two or more estimated performance metrics may be validated through historical large language prompt executions. For example, the accuracy, cost, and/or delay estimates associated with a language model performing a task may be validated using accuracy, cost, and/or a delay from previous executions of that same task and/or that same type of task by that language model. In various implementations, the two or more estimated performance metrics for each of the plurality of candidate language models associated with that model performing the task may be computed based on model performance benchmark repositories.

At step 720, as detailed above, a device may select a particular language model from among the plurality of candidate language models to optimize the two or more estimated performance metrics. For example, the particular language model may be selected based on having a relative highest accuracy performance metric when executing tasks with the task characterization as compared to other language models from among the plurality of candidate language models. In some examples, the particular language model may be selected from the plurality of candidate language models based on a relative evaluation of weighted estimated performance metrics across the plurality of candidate language models.

In various implementations, the prompt may be tokenized. A determination may be made regarding an amount of tokens associated with the performance of the task by each of the plurality of candidate language models. In such instances, the particular language model may be selected based on the amount of tokens associated with performance of the task and a token limit associated with each of the plurality of candidate language models.

At step 725, as detailed above, the device may cause the prompt to be sent to the particular language model for performance of the task. As such, the device may send the prompt to a most suitable LLM to process an individual prompt at inference time, considering the output of a PPU, normalized metrics (e.g., performance (P), cost (C), delay (D), etc.) associated to each of the LLMs available to the enterprise, and/or external sources of information (e.g., leaderboards, etc.).

Procedure 700 then ends at step 730.

It should be noted that while certain steps within procedure 700 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, leverage PPUs for dynamic model selection and routing in LLM model use. For example, these techniques leverage PPUs to assess an incoming prompt and its corresponding metadata, to characterize the prompt, and/or to inform an LLM selection process for execution of the prompt. These techniques may enable enterprises to dynamically identify the most suitable LLM to process an individual prompt at inference time, considering the output of a PPU, normalized metrics (e.g., performance (P), cost (C), delay (D), etc.) associated to each of the LLMs available to the enterprise, and/or external sources of information (e.g., leaderboards, etc.). By leveraging these mechanisms to dynamically select an optimal LLM for prompt execution on a prompt-by-prompt basis, enterprises are empowered to increase system performance, optimize operational/computational costs, and/or minimize delays associated with LLM utilization.

While there have been shown and described illustrative implementations that provide for dynamic model selection and routing using prompt processing units, it is to be understood that various other adaptations and modifications may be made within the spirit and scope of the implementations herein. For example, while certain implementations are described herein with respect to using certain elements, modules, components, architectures, etc. for the purposes of dynamic model selection and routing using prompt processing units, the elements, modules, components, architectures, etc. are not limited as such and may be used for other functions, in other arrangements, in other functional distributions, in other implementations, etc.

In addition, while certain types of metadata and data types/categories such as tasks, sensitive data, constraints, and outputs are shown, other suitable metadata and data types/categories may be used, accordingly. Moreover, while particular examples of the model selection being based on data/metrics such as performance, cost, delays, leaderboards, etc., are described, other suitable data/metrics related to the fit of an LLM model to execution of particular prompt may be utilized, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as tangible, non-transitory, computer-readable medium having computer-executable instructions stored thereon that, when executed by a processor on a computer, cause the computer to perform a method.

For example, the components and/or elements may be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, a task requested by a prompt for input to a language model;
computing, by the device and based on the task, two or more estimated performance metrics for each of a plurality of candidate language models associated with that model performing the task;
selecting, by the device, a particular language model from among the plurality of candidate language models to optimize the two or more estimated performance metrics; and
causing, by the device, the prompt to be sent to the particular language model for performance of the task.

2. The method as in claim 1, further comprising:
determining a task characterization for the task requested by the prompt for input to the language model.

3. The method as in claim 2, wherein the particular language model is selected based on having a relative highest accuracy performance metric when executing tasks with the task characterization as compared to other language models from among the plurality of candidate language models.

4. The method as in claim 1, further comprising:
tokenizing the prompt; and
determining an amount of tokens associated with performance of the task by each of the plurality of candidate language models.

5. The method as in claim 4, wherein the particular language model is selected based on the amount of tokens associated with performance of the task and a token limit associated with each of the plurality of candidate language models.

6. The method as in claim 1, wherein the two or more estimated performance metrics include a characterization of one or more of an accuracy, a cost, or a delay associated with a corresponding language model of the plurality of candidate language models associated with that model performing the task.

7. The method as in claim 1, further comprising:
validating the two or more estimated performance metrics through historical large language prompt executions.

8. The method as in claim 1, wherein the two or more estimated performance metrics for each of the plurality of candidate language models associated with that model performing the task are based on model performance benchmark repositories.

9. The method as in claim 1, wherein the particular language model is selected from the plurality of candidate language models based on a relative evaluation of weighted estimated performance metrics across the plurality of candidate language models.

10. The method as in claim 1, further comprising:
parsing the prompt to generate a prompt characterization, wherein the prompt characterization includes an indication of the task requested by the prompt.

11. An apparatus, comprising:
one or more network interfaces;
a processor coupled to the one or more network interfaces and configured to execute one or more processes; and
a memory configured to store a process that is executable by the processor, the process when executed configured to:
identify a task requested by a prompt for input to a language model;
compute, based on the task, two or more estimated performance metrics for each of a plurality of candidate language models associated with that model performing the task;
select a particular language model from among the plurality of candidate language models to optimize the two or more estimated performance metrics; and
cause the prompt to be sent to the particular language model for performance of the task.

12. The apparatus as in claim 11, the process when executed further configured to:
determine a task characterization for the task requested by the prompt for input to the language model.

13. The apparatus as in claim 12, wherein the particular language model is selected based on having a relative highest accuracy performance metric when executing tasks with the task characterization as compared to other language models from among the plurality of candidate language models.

14. The apparatus as in claim 11, the process when executed further configured to:
tokenize the prompt; and
determine an amount of tokens associated with performance of the task by each of the plurality of candidate language models.

15. The apparatus as in claim 14, wherein the particular language model is selected based on the amount of tokens associated with performance of the task and a token limit associated with each of the plurality of candidate language models.

16. The apparatus as in claim 11, wherein the two or more estimated performance metrics include a characterization of one or more of an accuracy, a cost, or a delay associated with a corresponding language model of the plurality of candidate language models associated with that model performing the task.

17. The apparatus as in claim 11, wherein the process, when executed, is further configured to:
validate the two or more estimated performance metrics through historical large language prompt executions.

18. The apparatus as in claim 11, wherein the two or more estimated performance metrics for each of the plurality of candidate language models associated with that model performing the task are based on model performance benchmark repositories.

19. The apparatus as in claim 11, wherein the particular language model is selected from the plurality of candidate language models based on a relative evaluation of weighted estimated performance metrics across the plurality of candidate language models.

20. A tangible, non-transitory, computer-readable medium storing program instructions that cause a device to execute a process comprising:
identifying a task requested by a prompt for input to a language model;
computing, based on the task, two or more estimated performance metrics for each of a plurality of candidate language models associated with that model performing the task;
selecting a particular language model from among the plurality of candidate language models to optimize the two or more estimated performance metrics; and
causing the prompt to be sent to the particular language model for performance of the task.
